(19) United States
(12) Patent Application Publication
(10) Pub. No.: US 2026/0129513 A1
(43) Pub. Date: May 7, 2026

(54) COMMUNICATION METHOD AND RELATED DEVICE

(71) Applicant: HUAWEI TECHNOLOGIES CO., LTD., Shenzhen (CN)

(72) Inventors: Rojan Chitrakar, Singapore (SG); Lei Huang, Singapore (SG); Yunbo Li, Shenzhen (CN); Xun Yang, Singapore (SG)

(73) Assignee: HUAWEI TECHNOLOGIES CO., LTD., Shenzhen (CN)

(21) Appl. No.: 19/439,352

(22) Filed: Jan. 3, 2026

Related U.S. Application Data
(63) Continuation of application No. PCT/CN2023/106440, filed on Jul. 7, 2023.

(51) Int. Cl. H04W 28/06; H04B 1/7163; H04L 5/00

(52) U.S. Cl. CPC H04W 28/06; H04B 1/7163; H04L 5/0044

(57) ABSTRACT

The present application applies to a wireless personal local network system based on ultra-wide band communication technology, a communication system based on ZigBee, a communication system based on IEEE 802.15.4 protocol. Embodiments of the present application provide a communication method, including: receiving a first protocol data unit (PPDU), where the first PPDU includes type instruction information, where the type instruction information is configured to indicate whether the first PPDU carries a compressed PHY (physical layer) service data unit (PSDU); and processing the information carried by the payload field of the first PPDU. According to the above-mentioned technical solution, the compressed PSDU may be identified according to the type instruction information carried by the PPDU. Therefore, a receiver of the PPDU may process the received PPDU according to the type instruction information.

### CROSS-REFERENCE TO RELATED APPLICATIONS

This application is a continuation of International Application No. PCT/CN2023/106440, filed on Jul. 7, 2023, the disclosure of which is hereby incorporated by reference in its entirety.

### TECHNICAL FIELD

Embodiments of the present application relate to the field of communication technologies, and more specifically, to a communication method and related devices.

### BACKGROUND

Ultra-wideband (UWB) technology is increasingly being used for indoor positioning and other location services such as access control and asset locating. Aside from dedicated devices and tags, UWB radios are becoming increasingly common in terminal devices. The UWB physical layer (PHY) and medium access control (MAC) are standardized by the Institute of Electrical and Electronics Engineers (IEEE).

Aside from the traditional ranging use case, other use cases such as device-free sensing, downlink time difference of arrival (DL-TDOA), long-range ranging, etc. are being actively investigated. To address the long-range ranging use case, UWB Multi-millisecond (MMS) ranging has been introduced. The key idea behind MMS ranging is to distribute the UWB ranging frames into multiple fragments and the fragment being transmitted across multiple milliseconds (ms), thereby overcoming the emitted energy limit of 37 nJ per ms. The MMS ranging may be further enhanced by a high-performance narrowband (NB) radio which is used to provide time synchronization for the UWB radio and is also used for control signaling. In MMS ranging, the number of fragments required for the ranging depends on the range to be measured as well as the channel conditions, and hence may be dynamically adjusted even within the same ranging session.

An MMS ranging session may include an initialization and setup phase followed by one or more range measurement cycles. During the initialization and setup phase, the frames are transmitted in the initialization channel, while during the measurement cycles, the frames are transmitted in the ranging channel. It is possible to use the same channel as both the initialization channel and the ranging channel.

In the initialization and setup phase, an initiator and a responder may negotiate ranging configuration, and the ranging configuration may be carried by a compressed PHY service data unit (PSDU). Ranging MMS packets may be exchanged between the initiator and the responder during the range-measurement cycle. Due to the nature of UWB transmissions (wide bandwidth, low transmission power), it is relatively harder to detect a UWB signal blindly (as compared to an NB signal). As such, in order to avoid accidental interference in the UWB channels, it is desirable to coordinate the UWB channel usage among UWB transmitters using either or both of the UWB and NB transceivers. This can be achieved by the UWB initiators periodically transmitting acquisition packets (AP) on some common well-known UWB and/or NB channels. When transmitted on NB channels, the AP message is known as an NB AP message and when transmitted on UWB channels, the AP message is known as a UWB AP message. Control information carried by the compressed PSDU may be exchanged between the initiator and the responder in the range-measurement cycle.

Both the compressed PSDUs and the NB AP message may be transmitted in the initialization channel. Since a format of the compressed PSDU is different from that of the NB AP message, a question arises: how to ensure the NB AP message and the compressed PSDU may coexist on the same channel, i.e., how can a receiving device differentiate the compressed PSDU from the NB AP message? This issue can be generalized as a coexistence issue between compressed PSDUs and any other packet transmitted on the NB channel and using the same physical layer (PHY), e.g., IEEE 802.15.4 offset quadrature phase-shift keying (O-QPSK) PHY.

### SUMMARY

Embodiments of the present application provide a communication method and related devices. The technical solution may be used for identifying a compressed PSDU.

According to a first aspect, an embodiment of the present application provides a communication method, including: receiving a first physical layer (PHY) protocol data unit (PPDU), where the first PPDU includes type instruction information, where the type instruction information is configured to indicate whether the first PPDU carries a compressed PHY service data unit (PSDU); and processing the information carried by the payload field of the first PPDU.

According to the above-mentioned technical solution, the compressed PSDU may be identified according to the type instruction information carried by the PPDU. Therefore, a receiver of the PPDU may process the received PPDU according to the type instruction information.

In a possible design, where the type instruction information is carried by a payload field of the first PPDU.

According to the above-mentioned technical solution, the type instruction information may only occupied bits in the payload field of the PPDU.

In a possible design, where the type instruction information occupies N bits within the payload of the first PPDU, N is a positive integer, when a value of the N bits of the payload field of the first PPDU is a first preset value, the first PPDU carries the compressed PSDU; or when a value of the N bits of the payload field of the first PPDU is different from the first preset value, the first PPDU carries a first wireless frame, where the first wireless frame is different from the compressed PSDU.

According to the above-mentioned technical solution, the type instruction may not only be used to indicate that the PPDU carries the compressed PSDU but also be used to indicate that the PPDY carries a wireless frame. The wireless frame may be used for carrying applications. For example, the wireless frame may be a data frame that carries an NB AP message. For another example, the wireless frame may be a frame carrying a ZigBee packet or the like.

In a possible design, where the N bits of the payload field of the first PPDU are a first 3 bits of the compressed PSDU, and bits 3 to 7 or bits 3 to 10 are configured to indicate a type of information carried by the compressed PSDU; or the N bits of the payload field of the first PPDU are 3 bits of a frame type field of the first wireless frame.

According to the above-mentioned technical solution, the type instruction may not only be used to indicate that the PPDU carries the compressed PSDU but also be used to indicate that the PPDY carries a wireless frame and a type of the wireless frame carried by the PPDU.

In a possible design, where the first preset value is 100.

According to the above-mentioned application, the reserved frame type value may be used to indicate that the payload of the PPDU is a compressed PSDU instead of a defined wireless frame (e.g., a beacon frame, a data frame, or the like).

In a possible design, where when the value of N bits of the payload field of the first PPDU is the first preset value, the compressed PSDU is carried by a second wireless frame, and the second wireless frame is carried by the payload of the first PPDU, where a type of the second wireless frame is different a type of the first wireless frame.

In a possible design, where the N bits include 3 bits of a frame type field of the second wireless frame and 3 bits of an extended frame type field of the second wireless frame, where the 3 bits of the frame type field indicates that the type of the second wireless frame is an extended frame, and the 3 bits of the extended frame type field indicates that the payload field of the extended frame carries the compressed PSDU.

In a possible design, where the N bits include 3 bits of a frame type field of a frame control field of the second wireless frame, and the 3 bits of the frame type field indicate that the type of the second wireless frame is a multipurpose frame, and the N bits further include 2 bits of a destination addressing mode field and 2 bits of a source addressing mode field of the frame control field of the second wireless frame, where the 2 bits of the destination addressing mode field indicate that a length of a destination address is 3 octets, or, the 2 bits of the source addressing mode field indicate that a length of a source address is 3 octets.

In a possible design, where when the first PPDU carries the first wireless frame, the first wireless frame includes application type indication information, where the application type indication information indicates a type of information carried by the first wireless frame.

In a possible design, the type of the information carried by the first wireless frame is a ZigBee message, a 6LoWPAN message, or an NB UWB message.

In a possible design, where the first wireless frame further includes application sub-type indication information, where the application sub-type indication information indicates a sub-type of the information carried by the first wireless frame.

In a possible design, where the type instruction information occupies N bits within the payload of the first PPDU, N is a positive integer, when a value of the N bits of the payload field of the first PPDU is a second preset value, the first PPDU carries the compressed PSDU and the compressed PSDU carries an application information; or when a value of the N bits of the payload field of the first PPDU is different from a second preset value, the first PPDU carries the compressed PSDU and the compressed PSDU carries a control information.

In a possible design, where when value of the N bits of the payload field of the first PPDU is the second preset value, the application information carried by the compressed PSDU is an NP AP message, or an NB data traffic.

In a possible design, where when the compressed PSDU carries the application information, a value of a message control field of the compressed PSDU indicates a type of the application information is the NP AP message, or the NB data traffic.

In a possible design, when the compressed PSDU carries the application information and the application information is first application information carrying a private address, the private address is carried by a transmitter address field of the compressed PSDU.

In a possible design, where when the value of the N bits of the payload field of the first PPDU is the second preset value, the compressed PSDU carries a third wireless frame, where the third wireless frame carries the application information.

In a possible design, where the type instruction information is carried by a PHY header field of the first PPDU.

In a possible design, where the type instruction information occupies one bit in the PHY header field of the first PPDU, when a value of the one bit is a third preset value, the PPDU carries the PSDU; when a value of the one bit is a fourth preset value, the PPDU carries a wireless frame that is different from the PSDU.

According to the above-mentioned technical solution, the type instruction information may only take up one bit in the PPDU. Therefore, the payload of the PPDU may be used to carrying more information.

In a possible design, where the method further includes: receiving at least one second PPDU, where the second PPDU includes a start transmission field, the start transmission field indicates a start or an end of an ultra-wideband (UWB) transmission in a UWB channel coupled with an NB channel for transmitting the second PPDU.

In a possible design, where when the UWB transmission is shorter in duration than twice transmission duration of the second PPDU, the receiving at least one second PPDU, includes: receiving one second PPDU at a starting time of the UWB transmission, where the start transmission field carried by the received second PPDU indicates the end of the UWB transmission; or when the UWB transmission is equal to or larger in duration than the twice transmission duration of the second PPDU, the receiving at least one second PPDU, includes: receiving two second PPDUs, where the two second PPDUs includes a start PPDU with a start transmission field indicating the start of the UWB transmission and an end PPDU with a start transmission field indicating the end of the UWB transmission, the start PPDU is received at a starting time of the UWB transmission, and an end time of the second PPDU is an end time of the UWB transmission.

According to a second aspect, an embodiment of the present application provides a communication method, including: generating a first physical layer PPDU; transmitting the first PPDU, where the first PPDU includes type instruction information, where the type instruction information is configured to indicate whether the first PPDU carries a compressed PHY service data unit (PSDU).

In a possible design, where the type instruction information is carried by a payload field of the first PPDU.

In a possible design, where the type instruction information occupies N bits within the payload of the first PPDU, N is a positive integer, when a value of the N bits of the payload field of the first PPDU is a first preset value, the first PPDU carries the compressed PSDU; or when a value of the N bits of the payload field of the first PPDU is different from the first preset value, the first PPDU carries a first wireless frame, where the first wireless frame is different from the compressed PSDU.

In a possible design, where the N bits of the payload field of the first PPDU are a first 3 bits of the compressed PSDU, and bits 3 to 7 or bits 3 to 10 are configured to indicate a type of information carried by the compressed PSDU; or the N bits of the payload field of the first PPDU are 3 bits of a frame type field of the first wireless frame.

In a possible design, where the first preset value is 100.

In a possible design, where when the value of N bits of the payload field of the first PPDU is the first preset value, the compressed PSDU is carried by a second wireless frame, and the second wireless frame is carried by the payload of the first PPDU, where a type of the second wireless frame is different a type of the first wireless frame.

In a possible design, where the N bits include 3 bits of a frame type field of the second wireless frame and 3 bits of an extended frame type field of the second wireless frame, where the 3 bits of the frame type field indicates that the type of the second wireless frame is an extended frame, and the 3 bits of the extended frame type field indicates that the payload field of the extended frame carries the compressed PSDU.

In a possible design, where the N bits include 3 bits of a frame type field of a frame control field of the second wireless frame, and the 3 bits of the frame type field indicate that the type of the second wireless frame is a multipurpose frame, and the N bits further include 2 bits of a destination addressing mode field and 2 bits of a source addressing mode field of the frame control field of the second wireless frame, where the 2 bits of the destination addressing mode field indicate that a length of a destination address is 3 octets, or, the 2 bits of the source addressing mode field indicate that a length of a source address is 3 octets.

In a possible design, where when the first PPDU carries the first wireless frame, the first wireless frame includes application type indication information, where the application type indication information indicates a type of information carried by the first wireless frame.

In a possible design, the type of the information carried by the first wireless frame is a ZigBee message, a 6LoWPAN message, or an NB UWB message.

In a possible design, where the first wireless frame further includes application sub-type indication information, where the application sub-type indication information indicates a sub-type of the information carried by the first wireless frame.

In a possible design, where the type instruction information occupies N bits within the payload of the first PPDU, N is a positive integer, when a value of the N bits of the payload field of the first PPDU is a second preset value, the first PPDU carries the compressed PSDU and the compressed PSDU carries an application information; or when a value of the N bits of the payload field of the first PPDU is different from a second preset value, the first PPDU carries the compressed PSDU and the compressed PSDU carries a control information.

In a possible design, where when value of the N bits of the payload field of the first PPDU is the second preset value, the application information carried by the compressed PSDU is an NP AP message, or an NB data traffic.

In a possible design, where when the compressed PSDU carries the application information, a value of a message control field of the compressed PSDU indicates a type of the application information is the NP AP message, or the NB data traffic.

In a possible design, when the compressed PSDU carries the application information and the application information is first application information carrying a private address, the private address is carried by a transmitter address field of the compressed PSDU.

In a possible design, where when the value of the N bits of the payload field of the first PPDU is the second preset value, the compressed PSDU carries a third wireless frame, where the third wireless frame carries the application information.

In a possible design, where the type instruction information is carried by a PHY header field of the first PPDU.

In a possible design, where the type instruction information occupies one bit in the PHY header field of the first PPDU, when a value of the one bit is a third preset value, the PPDU carries the PSDU; when a value of the one bit is a fourth preset value, the PPDU carries a wireless frame that is different from the PSDU.

In a possible design, where the method further includes: transmitting at least one second PPDU, where the second PPDU includes a start transmission field, the start transmission field indicates a start or an end of an ultra-wideband (UWB) transmission in a UWB channel coupled with an NB channel for transmitting the second PPDU.

In a possible design, where when the UWB transmission is shorter in duration than twice transmission duration of the second PPDU, the transmitting at least one second PPDU, includes: transmitting one second PPDU at a starting time of the UWB transmission, where the start transmission field carried by the received second PPDU indicates the end of the UWB transmission; or when the UWB transmission is equal to or larger in duration than the twice transmission duration of the second PPDU, the transmitting at least one second PPDU from, includes: transmitting two second PPDUs, where the two second PPDUs includes a start PPDU with a start transmission field indicating the start of the UWB transmission and an end PPDU with a start transmission field indicating the end of the UWB transmission, the start PPDU is received at a starting time of the UWB transmission, and an end time of the second PPDU is an end time of the UWB transmission.

According to a third aspect, an embodiment of this application provides a communication apparatus, and the communication apparatus has function of implementing the method in the first aspect or any possible implementation of the first aspect. The function may be implemented by hardware, or may be implemented by hardware executing corresponding software. The hardware of the software includes one or more modules corresponding to the function.

According to a fourth aspect, an embodiment of this application provides a communication apparatus, and the communication apparatus has function of implementing the method in the second aspect or any possible implementation of the second aspect. The function may be implemented by hardware, or may be implemented by hardware executing corresponding software. The hardware of the software includes one or more modules corresponding to the function.

According to a fifth aspect, an embodiment of this application provides a computer readable storage medium, including instructions. When the instructions run on a computer, the computer is enabled to perform the method in the first aspect or any possible implementation of the first aspect.

According to a sixth aspect, an embodiment of this application provides a computer readable storage medium, including instructions. When the instructions run on a computer, the computer is enabled to perform the method in the second aspect or any possible implementation of the second aspect.

According to a seventh aspect, A communication apparatus is provided, including a processor and a memory. The processor is connected to the memory. The memory is configured to store instructions, the processor is configured to execute the instructions. When the processor executes the instructions stored in the memory, the processor is enabled to perform the method in the first aspect or any possible implementation of the first aspect.

According to an eighth aspect, A communication apparatus is provided, including a processor and a memory. The processor is connected to the memory. The memory is configured to store instructions, the processor is configured to execute the instructions. When the processor executes the instructions stored in the memory, the processor is enabled to perform the method in the second aspect or any possible implementation of the second aspect.

According to a ninth aspect, a chip system is provided, where the chip systems includes an input/output interface, at least one processor, at least one memory, and a bus, where the at least one memory is configured to store instructions, and the at least one processor is configured to invoke the instructions of the at least one memory and run the instructions, so that A communication apparatus on which the chip is disposed performs the method in the first aspect or any possible implementation of the first aspect.

According to a tenth aspect, a chip system is provided, where the chip systems includes an input/output interface, at least one processor, at least one memory, and a bus, where the at least one memory is configured to store instructions, and the at least one processor is configured to invoke the instructions of the at least one memory and run the instructions, so that A communication apparatus on which the chip is disposed performs the method in the second aspect or any possible implementation of the second aspect.

According to an eleventh aspect, a computer program product is provided, wherein when the computer program product runs on a communication apparatus, the communication apparatus is enabled to perform the method in the first aspect or any possible implementation of the first aspect.

According to a twelfth aspect, a computer program product is provided, wherein when the computer program product runs on a communication apparatus, the communication apparatus is enabled to perform the method in the second aspect or any possible implementation of the second aspect.

### DESCRIPTION OF DRAWINGS

FIG. 1 illustrates an example communication system.

FIG. 2 illustrates an initialization and setup phase followed by measurement cycles.

FIG. 3 illustrates a compressed PSDU format.

FIG. 4 illustrates a general MAC from.

FIG. 5 illustrates a frame control field.

FIG. 6 illustrates a relationship between a PHY protocol data unit (PPDU), a data frame and an NB AP message.

FIG. 7 illustrates a relationship between the PPDU and the compressed PSDU.

FIG. 8 illustrates a diagram of a communication method in accordance with some embodiments of the present application.

FIG. 9 illustrates compressed PSDUs in accordance with some embodiments of the present application.

FIG. 10 illustrates the extended frame in accordance with some embodiments of the present application.

FIG. 11 illustrates the multipurpose frame in accordance with some embodiments of the present application.

FIG. 12 illustrates the second compressed PSDU in accordance with some embodiments of the present application.

FIG. 13 illustrates a PPDU carrying the type instruction information in accordance with some embodiments of the present application.

FIG. 14 illustrates a data frame including the application type field and the application sub-type field.

FIG. 15 illustrate another data frame including the application type field and the application sub-type field.

FIG. 16 illustrate a PPDU carrying the start transmission field.

FIG. 17 illustrates a relationship between the second PHY data unit and the UWB transmission.

FIG. 18 is a schematic block diagram of a communication apparatus according to some embodiments of the present application.

FIG. 19 is a schematic block diagram of a communication apparatus according to some embodiments of the present application.

FIG. 20 is a schematic block diagram of a communication apparatus according to some embodiments of the present application.

### DESCRIPTION OF EMBODIMENTS

The following describes the technical solutions in the present application with reference to the accompanying drawings.

In the embodiments of the present application, “at least one” means one or more, and “a plurality of” means two or more. The term “and/or” describes an association relationship between associated objects and represents that three relationships may exist. For example, A and/or B may represent the following three cases: only A exists, both A and B exist, and only B exists, where A and B may be singular or plural. The character “I” generally indicates an “or” relationship between the associated objects. “At least one of the following” and a similar expression thereof refer to any combination of these items, including any combination of one item or a plurality of items. For example, at least one of a, b, and c may indicate: a, b, c, a and b, a and c, b and c, or a, b, and c, where a, b, and c may be singular or plural.

For a better understanding of a communication method in the embodiments of this application, the following briefly describes some related basic concepts.

Before describing the solutions in the present disclosure, relevant nomenclature will be introduced as follows.

Controller: a device that controls a UWB session and defines session parameters.

Controlee: a device that utilizes the session parameters received from the controller to participate in the UWB session.

Initiator: a device that follows the instruction from the controller, and initiates a UWB exchange by sending a first message of the exchange. A controller or a controlee can be an initiator.

Responder: a device that responds to the first message received from the initiator and participates in the UWB exchange. A controller or a controlee can be a responder.

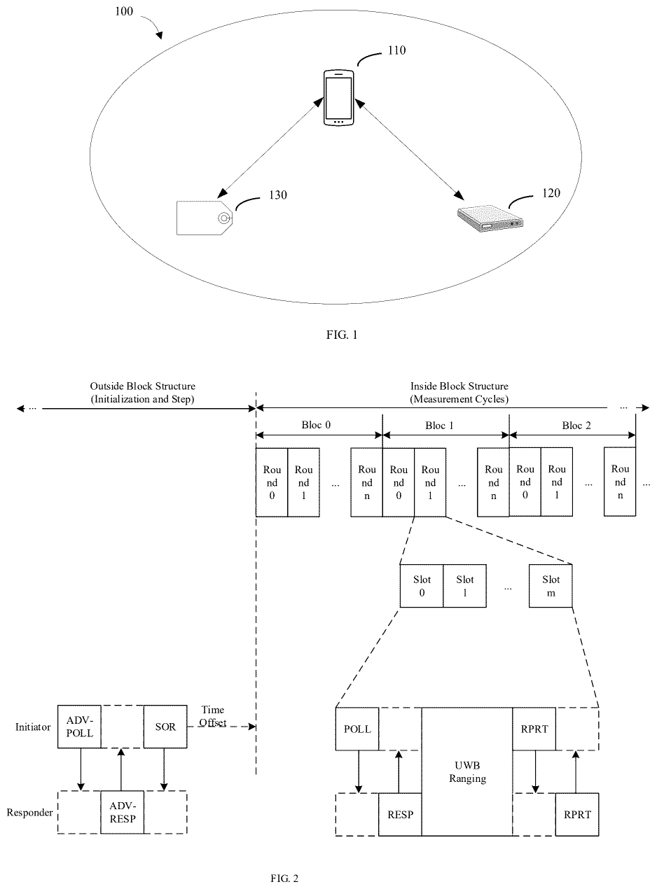

FIG. 1 illustrates an example communication system 100.

In the communication system 100, a first device 110 can communicate with other multiple devices, such as a second device 120, and a third device 130. The communication can carry applications such as ranging, sensing, and time difference of arrival (TDOA).

In some embodiments, the first device 110 may be a controller (initiator) while the second device 120 and the third device 130 may be controlees (responders).

In some other embodiments, the second device may be a controller (initiator), while the first device 110 and the third device 130 may be controlees (responders).

FIG. 2 illustrates an initialization and setup phase followed by measurement cycles.

Referring to FIG. 2, in the initialization and setup phase, an initiator may transmit advertising poll (ADV-POLL) frames opportunistically at times. Correspondingly, the responder may opportunistically listen for incoming ADV-POLL frames. Once the responder has received an ADV-POLL frame, the responder may transmit an advertising response (ADV-RESP) frame to the initiator. Once the initiator has received the ADV-RESP frame, the initiator may transmit a start-of-ranging (SOR) frame in a ranging slot following the ADV-RESP frame, indicating the time at which the range-measurement cycle will start. A range-measurement cycle may include a ranging control phase, a ranging phase and an optional measurement report phase. The ranging control phase starts at the beginning of the range-measurement cycle. The initiator starts the ranging control phase by transmitting a poll (POLL) frame to the responder at the beginning of the first ranging slot of a ranging round. Once the responder has received the POLL frame successfully, the responder may transmit a response (RESP) frame to the initiator. The POLL and RESP frames allow the initiator and the responder to achieve time and frequency synchronization. The initiator may also include other control information in the POLL frame for the responder.

As mentioned earlier, the key idea behind MMS ranging is to distribute the UWB ranging frames into multiple fragments and the fragment being transmitted across multiple milliseconds, thereby overcoming the emitted energy limit of 37 nJ per ms. By distributing the ranging frame over several fragments, each fragment being transmitted in one millisecond, the total energy of the ranging frame can be several times higher, thereby considerably increasing the ranging range. This means that when the block-based mode is used for MMS ranging, the control frame transmission time would be limited to 1 ms as well. Particularly in the NBA-MMS mode, at the lowest data rate of 250 kbps for the O-QPSK PHY, the NB frame size is limited to 25 bytes in a ms. If the general legacy 802.15.4-2020 frame format illustrated in FIG. 4 is used, due to the overhead of the MHR field and the information elements (IEs), the available space for the actual control information would be very limited.

In order to overcome this size limitation, a compressed PSDU format that uses private address has been introduced, and the compressed PSDU may be used to transmit information with a specific transmission duration limit, such as 1 ms. The ADV-POLL frame, the ADV-RESP frame, the POLL frame, and the RESP frame may be carried in the compressed PSDU.

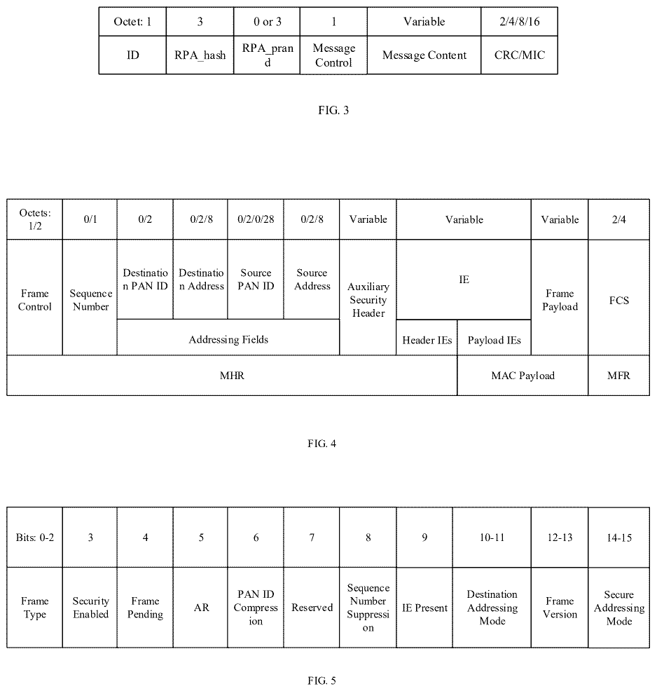

FIG. 3 illustrates a compressed PSDU format.

Referring to FIG. 3, the compressed PSDU with a private address may include: a 1-octet message ID field, a 3-octet private address field that carries an RPA_hash, an optional 3-octet field that carries an RPA_prand, a 1-octet message control field that determines a format of a message content field, a variable length message content field whose format depends on a content of the message content field, and a 2-octet cyclic redundancy check (CRC) field. The optional 3-octet field may be present in a compressed PSDU which carries certain frames (e.g., the ADV-POLL frame or the POLL frame) and absent in a compressed PSDU which carries other frames (e.g., the ADV-RESP fame, the RESP frame, or the SOR frame).

The message content field of the compressed PSDU may be used to carry the payload of the above-mentioned frames. In addition to the above-mentioned frames, the message content field may further be used to carry other messages. For convenience, a term “control information” refers to information carried by the compressed PSDU, e.g., the control information may include the payload of the above-mentioned frames, the control information may further include information carried by other fields (e.g., the ID field, the RPA_hash field, the message control field or the like). In some embodiments, the control information may be regarded as the compressed PSDU.

A value of the message ID field is used to indicate a type of the control information carried by the message content field. A relationship between the value of the message ID field and the type of the control information carried by the message content field is shown in Table 1.

TABLE 1

| Compressed PSDU | ID value |
|---|---|
| ADV-POLL | 0x04 |
| ADV-RESP | 0x0C |
| SOR | 0x14 |
| ADV-CONF | 0x1C |
| POLL | 0x24 |
| RESP | 0x2C |
| RPRT | 0x34 |
| RPRT | 0x3C |
| PUBLIC-ADV-POLL | 0x44 |
| PUBLIC-ADV-RESP | 0x4C |
| PUBLIC-SOR | 0x54 |
| SECURE-ADV-RESP | 0x5C |
| SECURE-SOR | 0x64 |
| SECURE-POLL | 0x6C |
| SECURE-RESP | 0x74 |
| SECURE-POLL (One-to-many) | 0x7C |
| SECURE-REPORT (from initiator) | 0x84 |
| SECURE-REPORT (from responder) | 0x8C |
| Reserved | 0x94-0xF4 |
| Vendor Specific | 0xFC |

In IEEE 802.15.4, several medium control address (MAC) frames are defined, and different types of MAC frames serve different purposes, including data transmission, network synchronization, reliability assurance, and so on.

FIG. 4 illustrates a general MAC from for frame type values other than fragment and extended as defined in Table 2.

Fields of a MAC header (MHR) shown in FIG. 4 appear in a fixed order; however, some fields shown in FIG. 4 may not be included in all frames.

FIG. 5 illustrates a frame control field for frames other than a multipurpose frame, a fragment frame, a frak frame and an extended frame.

A value of a frame type field is used to indicate a frame type, and the frame type field may be set as defined in Table 2.

TABLE 2

| Frame Type | |
|---|---|
| b2 b1 b0 | Description |
| 000 | Beacon |
| 001 | Data |
| 010 | Acknowledgment |
| 011 | MAC Command |
| 100 | Reserved |
| 101 | Multipurpose |
| 110 | Fragment or Frak |
| 111 | Extended |

The MAC frame is passed to the PHY as a PHY service data unit (PSDU), which becomes the PHY payload. A size of the MAC frame may be less than the maximum PHY service data unit (PSDU) size supported by the PHY in use. The NB AP message may be carried by a payload field of the MAC frame.

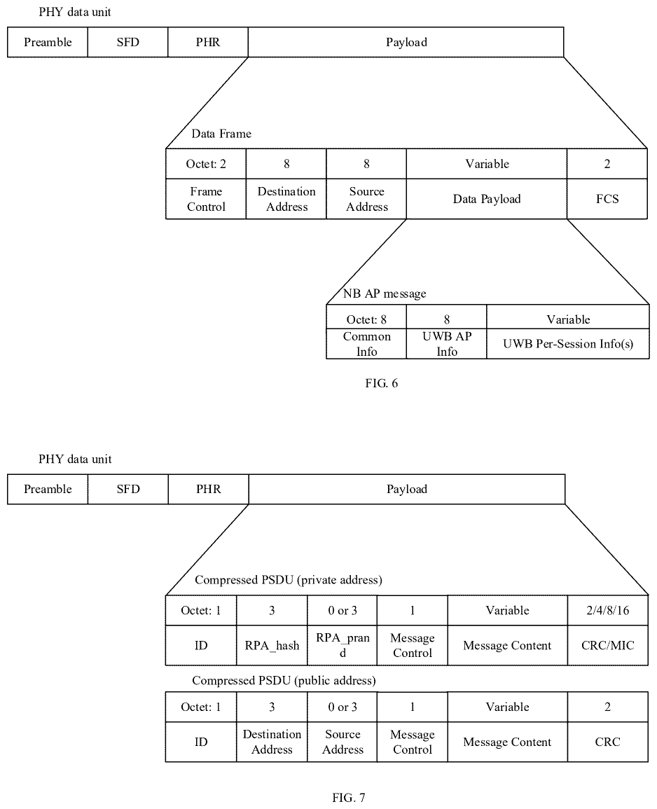

FIG. 6 illustrates a relationship between a PHY protocol data unit (PPDU), a data frame and an NB AP message.

Referring to FIG. 6, a payload field of a data frame carries the data frame, and a payload field of the MAC frame carries the NB AP message. In addition to the data frame, the PPDU may also be used to carry other types of MAC frames, e.g., the multipurpose frame, the extended frame, or the like. Further, other application (such as ZigBee, internet protocol version 6 (IPv6) over low power wireless personal area network (6LoWPAN)) or even other NB data applications (such as UWB-based payment portal applications) may also be carried by the payload of the PPDU. For convenience, a term “application information” refers to application data carried by the payload of the PPDU. In other words, the application information may include ZigBee application data, 6LoWPAN application data, NB UWB application data, or the like, and the NB UWB application data may include the NB AP message, an NB data packet that is used to carry a payload of applications such as payment gateways, or the like. The application information (e.g., the ZigBee application data, the 6LoWPAN application data, and the NB UWB application data) may be encapsulated into a package with other information (e.g., address information, header, or the like), and the package is carried by the payload field of the PPDU. For example, the application information may be carried as a payload of wireless frames (e.g., the MAC frame). Therefore, in some embodiments, the application information may also be regarded as a wireless frame, a MAC frame, a legacy 802.15.4 frame, or the like, and the wireless frame (the MAC frame or the legacy 802.15.4 frame) carries the ZigBee application data, the 6LoWPAN application data, the NB UWB application data, or the like. For ease of description, in the following embodiments, it is assumed that the term “application information” merely be used to refer to the application data carried by the package within the payload of the PPDU. In other words, in the following embodiments, the “application information” only includes the ZigBee application data, the 6LoWPAN application data, the NB UWB application data (including the NB AP message, an NB data packet that is used to carry a payload of applications such as payment gateways, and so on), or the like.

The PPDU may also be used to carry the compressed PSDU. FIG. 7 illustrates a relationship between the PPDU and the compressed PSDU. Referring to FIG. 7, the payload of the PPDU carries the compressed PSDU.

FIG. 8 illustrates a diagram of a communication method in accordance with some embodiments of the present application.

801, A first communication apparatus receives a PHY data unit from a second communication apparatus.

802, The first communication apparatus may process information carried by the PHY data unit.

In some embodiments, the PHY data unit may be the PPDU mentioned above.

The first communication apparatus may process the information carried by the PPDU according to a type of the information indicated by type instruction information

Referring to the above-mentioned description, since the initiator may transmit the PPDU carrying the control information (e.g., the ADV-POLL frame or the POLL frame) to the responder and the responder may also transmit the PPDU carrying the control information (e.g., the RESP frame), the first communication apparatus, in some embodiments, may be the initiator and the second communication apparatus may be the responder, while in other embodiments, the first communication apparatus may be the responder and the second communication apparatus may be the initiator.

A communication apparatus (such as the first communication apparatus and the second communication apparatus) may be an apparatus or a component of the apparatus (such as a circuit or a chip). The apparatus may be a terminal device (e.g., a mobile phone, a wearable device, a smart watch, a virtual reality (VR) device, an augmented reality (AR) device, a mixed reality (MR) device, or the like), a computer device (e.g., a personal computer (PC), a laptop computer, a tablet, or the like), a vehicle (such as an electric car, a hybrid car, a petrol car, a motorcycle, or the like), an Internet of things (IoT) device, or the like.

In some embodiments, the first communication apparatus may be the first device 110 illustrated in FIG. 1, and the second communication apparatus may be the second device 120 or the third device 130 illustrated in FIG. 1. In some other embodiments, the first communication apparatus may be the second device 120 illustrated in FIG. 1, and the second communication apparatus may be the first device 110 or the third device 130 illustrated in FIG. 1.

The PHY data unit may include type instruction information. The type instruction information is configured to indicate a type of the information carried by the PHY data unit. The type of the information carried by the PHY data unit may be a compressed PSDU. In other words, the type may be configured to indicate whether the PHY data unit carries a compressed PSDU.

In some embodiments, the type instruction information may be carried by the payload field of the PHY data unit. For example, the payload field of the PHY data unit may include one or more bits, a value of which is used to indicate the type of the information carried by the PHY data unit. In other words, the type instruction information may occupy N bits of the payload field of the PHY data unit, where a value of the N bits is used to indicate the type of the information carried by the PHY data unit, and N is a positive integer.

In some embodiments, the N bits are first N bits of the payload field of the PHY data unit. In other words, the N bits are a first N least significant bits (LSB) of the payload field of the PHY data unit.

In some embodiments, N is equal to 3. If the payload field of the PHY data unit carries a wireless frame carrying the application information, and if the wireless frame is a MAC frame, the first 3 bits of the MAC frame are the frame type field. Referring to Table 2, the value of the frame type field 100 is reserved. Therefore, the type instruction information may utilize the reserved value to indicate that the compressed PSDU is carried by the payload field of the PHY field. For example, if the value of the first 3 bits of the payload field of the PHY data unit (that is, the value of the frame type) is b100, the payload field of the PHY data unit carries the control information; if the value of the first 3 bits of the payload field of the PHY data unit is not b100, the payload field of the PHY data unit carries a MAC frame, and the type of the MAC frame is indicated by the first 3 bits of the payload field of the PHY data unit. For example, after receiving the PHY data unit, the first communication apparatus may check the first 3 bits of the payload field of the PHY data unit. If the value of the first 3 bits of the PHY data unit is b001, the first communication apparatus may determine that the payload field of the PHY data unit carries a data frame and obtain, for example, the NB AP message from the payload field of the data frame. However, if the value of the first 3 bits of the payload field of the PHY data unit is b100, the first communication apparatus may determine that the payload field of the PHY data unit carries the compressed PSDU. Since the reserved value of the frame type field is used to indicate that the payload of the PHY data unit carries the compressed PSDU, the reserved value b100 is no longer reserved, and the frame type field may be set as defined in Table 3.

TABLE 3

| Frame Type | |
|---|---|
| b2 b1 b0 | Description |
| 000 | Beacon |
| 001 | Data |
| 010 | Acknowledgment |
| 011 | MAC Command |
| 100 | Used for coexistence with compressed |
| | PSDU |
| 101 | Multipurpose |
| 110 | Fragment or Frak |
| 111 | Extended |

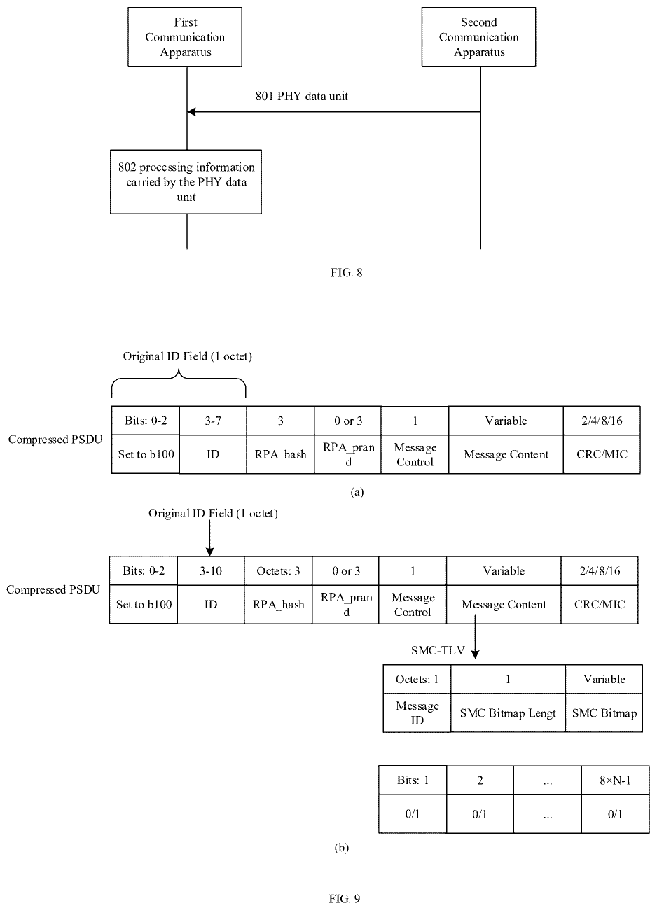

FIG. 9 illustrates compressed PSDUs in accordance with some embodiments of the present application.

Referring to (a) in FIG. 9, when the payload field of the PHY data unit carries the compressed PSDU, the first 8 bits of the payload field of the PHY data unit is the ID field of the compressed PSDU, and the first 3 bits of the payload field of the PHY data unit are a first 3 bits of the ID field of the compressed PSDU. Therefore, the rest bits of the ID field (that is, bits 3 to 7) may be used to indicate the type of the control information carried by the compressed PSDU. The new message ID of the compressed PSDUs and the value of the original 1-octet ID field is shown in Table 4.

TABLE 4

| | | Original ID value |
|---|---|---|
| | Message ID | (b7 b6 b5 b4 b3 b2 |
| Compressed PSDU Message | (b7 b6 b5 b4 b3) | b1 b0) |
| ADV-POLL | 0x00 | 0x04 |
| ADV-RESP | 0x01 | 0x0C |
| SOR | 0x02 | 0x14 |
| ADV-CONF | 0x03 | 0x1C |
| POLL | 0x04 | 0x24 |
| RESP | 0x05 | 0x2C |
| RPRT | 0x06 | 0x34 |
| RPRT | 0x07 | 0x3C |
| PUBLIC-ADV-POLL | 0x08 | 0x44 |
| PUBLIC-ADV-RESP | 0x09 | 0x4C |
| PUBLIC-SOR | 0x0A | 0x54 |
| SECURE-ADV-RESP | 0x0B | 0x5C |
| SECURE-SOR | 0x0C | 0x64 |
| SECURE-POLL | 0x0D | 0x6C |
| SECURE-RESP | 0x0E | 0x74 |
| SECURE-POLL (One-to-many) | 0x0F | 0x7C |
| SECURE-REPORT (from | 0x10 | 0x84 |
| initiator) | | |
| SECURE-REPORT (from | 0x11 | 0x8C |
| responder) | | |
| Reserved | 0x12-0x1E | 0x94-0xF4 |
| Vendor Specific | 0x1F | 0xFC |

Referring to Table 4, an ID space of the compressed PSDU is reduced to 5 bits and the number of unique compressed PSDUs is reduced to 32.

According to the above-mentioned embodiments, the control information is carried by the message content field of the compressed PSDU, and the application information is carried by the payload field of the wireless frame. If the value of the first 3 bits of the payload field of the PHY data unit is a dedicated value (that is, b100, b0=0, b1=0, b2=1)), the payload of the PHY data unit carries the compressed PSDU, and if the value of the first 3 bits of the payload field of the PHY data unit is a preset value instead of the dedicated value, the payload of the PHY data unit carries the wireless frame, and the wireless frame is different from the compressed PSDU. For convenience, the dedicated value which is used to indicate that the PHY data unit carries the compressed PSDU be referred to as a first preset value.

Alternatively, the new ID field can still be 8 bits, starting at the 4th bit (b3) of the PHY payload field. That is to say the original ID field is extended from 1 octet (8 bits) to 11 bits with the first 3 bits set to the dedicated value of b100. This means the original ID space is maintained with no changes to the message ID values. This is illustrated in (b) of FIG. 9.

In addition, an example content carried in the message content field when the compressed PSDU is an ADV-POLL is also shown in (b) of FIG. 9. The message content field of an ADV-POLL may carry one more supported message control type length values (SMC-TLVs). Each SMC-TLV indicates the supported message controls for a particular compressed PSDU message indicated by the message ID field. The SMC bitmap length indicates the length of the SMC bitmap field in unit of octet. Each bit in the SMC bitmap indicates a message control ID supported by the device for that compressed PSDU. E.g., in (b) of FIG. 9, the message ID may be set as 0x00 (ADV-POLL) and the SMC bitmap length is set as 1, and the bits of the SMC bitmap maps to message control IDs 0x20, 0x21, . . . , 0x27, each bit set to 1 indicating that the device supports an ADV-POLL message with the mapped message control ID.

In some embodiments, a payload of a wireless frame may be used to carry the application information, and a payload of another wireless frame may be used to carry a compressed PSDU. The type instruction information may be carried by the frame control field of the wireless frame. For convenience, the wireless frame carrying the compressed PSDU may be referred to as a first type of wireless frame, and the wireless frame carrying not carrying the compressed PSDU (e.g., the wireless frame carrying the application information) may be referred to as a second type of wireless frame. The wireless frame may be a MAC frame, a legacy 802.15.4 frame, or the like.

In some embodiments, an extended frame with a dedicated extended frame type may be used to carry the compressed PSDU. In other words, the first wireless frame may be an extended frame with a dedicated extended frame type.

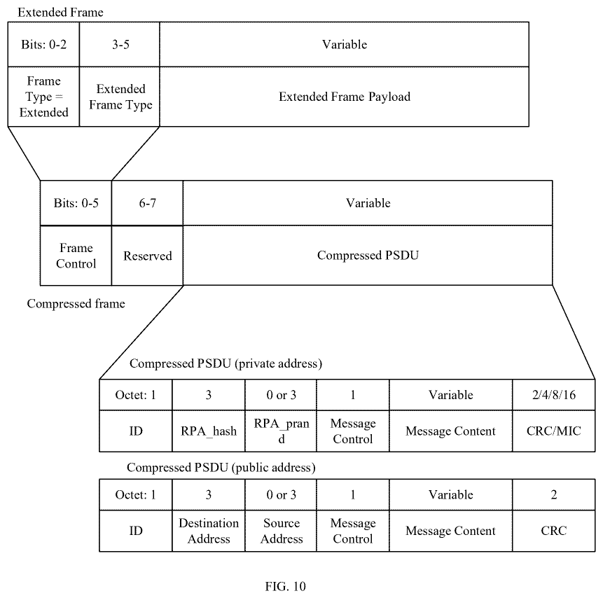

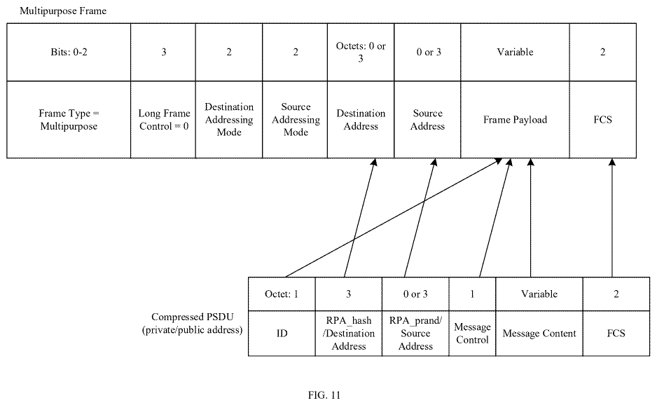

FIG. 10 illustrates the extended frame in accordance with some embodiments of the present application.

Referring to FIG. 10, the extended frame includes a 6-bit frame control field and an extended frame payload field with a variable length. The frame control field of the extended frame includes a frame type field and an extended frame type field. Referring to Table 2, for the extended frame shown in FIG. 8, the value of the frame type field should be b111. A value of the extended frame type field may be used to indicate that the extended frame payload field of the extended frame carries the compressed PSDU. For example, when the value of the extended frame type field is b000, the extended frame payload field of the extended frame carries the compressed PSDU. In order to align with the octet boundary, the first two bits of the extended frame payload field (i.e., bits 6 & 7 of the first octet of the PPDU payload field) may be reserved and the compressed PSDU starts from the third bit of the extended frame payload field. The compressed PSDU may be a private address version or a public address version.

Table 5 shows a relationship between the value of the extended frame type field and type of information carried by the extended frame payload field.

TABLE 5

| Extended Frame Type | |
|---|---|
| b5 b4 b3 | Description |
| 000 | Compressed PSDU |
| 001-011 | Reserved |
| 111 | Assigned to telecommunications industry |
| | association (TIA) |

For the first communication apparatus, after receiving the PHY data unit from the second communication apparatus, the first communication apparatus may check the first 3 bits of the payload field of the PHY data unit. If the value of the first 3 bits of the payload field of the PHY data unit is b001, the first communication apparatus may determine that the payload field of the PHY data unit carries a data frame and obtain, for example, the NB AP message from the payload field of the data frame. However, if the value of the first 3 bits of the payload field of the PHY data unit is b111, the first communication apparatus may further check bits 3 to 5 of the payload field of the PHY data unit and determine that the payload field of the PHY data unit carries the compressed PSDU when the value of the bits 3 to 5 is b000. Therefore, the N bits corresponding to the type instruction information may be regarded as first N bits of the frame control field of the wireless frame. When the wireless frame is the extended frame, the first N bits of the frame control field may be the first 6 bits of the frame control field; or when the wireless frame is not the extended frame, the first N bits of the frame control field may be the first 3 bits of the frame control field.

In some other embodiments, a multipurpose frame may be used to carry a compressed PSDU. In other words, the first wireless frame may be a multipurpose frame.

FIG. 11 illustrates the multipurpose frame in accordance with some embodiments of the present application.

Referring to FIG. 11, the multipurpose frame includes 1 octet frame control field, 3 bits RPA_hash or destination address field, 0 or 3-bits RPA_prand or source address field, a frame payload field with a variable length, and a 2-octet FCS field that carries the CRC or a 2/4/8/16-octets MIC field. The frame control field includes a frame type field, a long frame control field, a destination addressing mode field and a source addressing mode field. Referring to Table 2, for the multipurpose frame, the value of the frame type field should be b101. The addressing mode field is defined in Table 6, where the addressing mode field includes the destination addressing mode field and the source addressing mode field.

TABLE 6

| Addressing Mode | |
|---|---|
| b1 b0 | Description |
| 00 | PAN ID and address fields are not |
| | present. |
| 01 | Address field contains a 3-octet address |
| | or prand (24 bits). |
| 10 | Address field contains a short address |
| | (16 bits). |
| 11 | Address field contains an extended |
| | address (64 bits). |

The destination addressing mode field in the frame control field is set as b01 to indicate that the destination address field in the MAC header (MHR) is present and carries either a 3-octet RPA_hash (for private address variant compressed PSDU) or a 3-octet destination address (for public address variant compressed PSDU). Similarly, the source addressing mode field in the frame control field is set as b00 to indicate that the source address field is not present in the MHR or 01 to indicate that the source address field in the MHR is present and carries either a 3-octet RPA_prand (for private address variant compressed PSDU) or a 3-octet source address (for public address variant compressed PSDU). Since the compressed PSDU uses 3-octet address fields, the value of the destination addressing mode field and the value of the source addressing mode field may be used to indicate whether the multipurpose fame carries the compressed PSDU. For example, when the value of the destination addressing mode field is b01 or when the value of the source addressing mode field is b01, the multipurpose frame carries the compressed PSDU. In other words, if at least one of the values of the destination addressing mode field or the values of the source addressing mode field is b01, the multipurpose frame carries the compressed PSDU. The frame payload of the multipurpose frame may be used to carry the ID field, the message control field and the message content field of the compressed PSDU, and the FCS field of the multipurpose frame may be used to carry the CRC of the compressed PSDU. The message content field of the compressed PSDU may carry the control information. When the compressed PSDU is a secure compressed PSDU (e.g., the ID field of the compressed PSDU indicates that the compressed PSDU carries a secure frame (e.g., a SECUR-ADV-POLL frame, a SECURE-SOR frame, or the like), the FCS field may be used to carry a message integrity code (MIC) of the compressed PSDU instead of the CRC. Further, the destination address field of the multipurpose frame carries the RPA_hash in the RPA_hash field of the compressed PSDU in a private address variant or the destination address in the destination address field of the compressed PSDU in a public address variant, and the source address field of the multipurpose frame carries the RPA_prand in the RPA_prand field of the compressed PSDU in the private address variant or the source address in the source address field of the compressed PSDU in the public address variant.

For the first communication apparatus, after receiving the PHY data unit from the second communication apparatus, the first communication apparatus may check the first 3 bits of the payload field of the PHY data unit. If the value of the first 3 bits of the payload field of the PHY data unit is b001, the first communication apparatus may determine that the payload field of the PHY data unit carries a data frame and obtain, for example, the NB AP message from the payload field of the data frame. However, if the value of the first 3 bits of the payload field of the PHY data unit is b101, the first communication apparatus may further check the destination addressing mode field and/or the source addressing mode field and determine that the payload field of the PHY data unit carries the compressed PSDU when the value of the destination addressing mode field and/or the source addressing mode field is b01. Therefore, the N bits corresponding to the type instruction information may be regarded as N bits of the frame control field of the wireless frame. When the wireless frame is the multipurpose frame, the N bits of the frame control field may include the first 3 bits of the frame control field and bits 4 to 7 of the frame control field; or when the wireless frame is not the multipurpose frame, the N bits of the frame control field may be the first 3 bits of the frame control field.

In some embodiments, a compressed PSDU may be used for carrying the application information. A value of an ID field of a compressed PSDU carrying the application information is different from a value of an ID field of other compressed PSDUs. For convenience, the compressed PSDU not carrying the application information may be referred to as a first compressed PSDU, while the compressed PSDU carrying the application information may be referred to as a second compressed PSDU. In some embodiments, the first compressed PSDU may be used for carrying the control information.

The value of the ID field of the first compressed PSDU may be an unreserved value in Table 1. In other words, the value of the ID field of the first compressed PSDU may be any one of the ID values excluding the reserved values. Correspondingly, a unique value of the ID field is assigned for the second compressed PSDU. For example, the value of the ID field of the second compressed PSDU may be 0x50 or 0x00, etc.

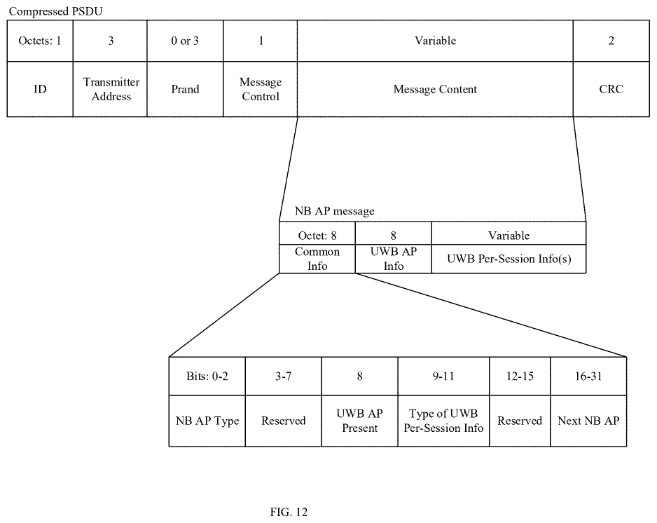

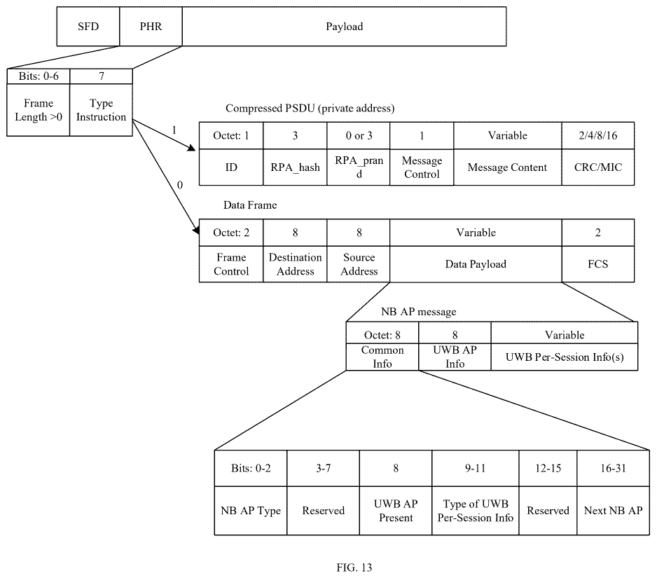

FIG. 12 illustrates the second compressed PSDU in accordance with some embodiments of the present application.

Referring to FIG. 12, the second compressed PSDU includes: a 1-octet ID field, a 3-octet transmitter address field, an optional prand field, a 1-octet message control field, a message content field with a variable length, and a 2-octet CRC field.

The ID field of the second compressed PSDU is set as a preset value (e.g., 0x50) to represent that the second compressed PSDU is configured to carry application information.

In some embodiments, the transmitter address field may be a randomly generated 3-octet address representing a transmitting device or a private address representing a transmitter. In some applications, a randomly generated address is expected to be used, but in some scenarios when the NB AP messages are directed (i.e., expected to be decoded by devices in the same network), or when all devices in the vicinity are in possession of a common identity resolving key (IRK), a private address may be used.

In some embodiments, the optional prand field may be present only in the first frame carrying a new private address. The private address is only used in directed NB AP messages, where the directed NB AP messages are transmitted to a particular device or network.

In some embodiments, the message control field of the second compressed PSDU may be used to indicate the type of the NB data carried in the message content field of the second compressed PSDU. For example, if the value of the message control field of the second PSDU is b0, the message content field of the second compressed PSDU may carry an NB AP message; or if the value of the message control field of the second PSDU is b1, the message content field of the second compressed PSDU may carry an NB data traffic.

The message content field of the second compressed PSDU may be used to carry the application information. For example, the message content field of the second compressed PSDU may carry the NB AP message, the NB data traffic, or the like.

FIG. 12 also shows the NB AP message carried in the message content field of the second compressed PSDU. Referring to FIG. 12, the NB AP message includes an 8-octet common information (info) field, an 8-octet UWB AP info field, and a UWB per-session info(s) field, wherein the 8-octet common info field includes a 0-2 bits NB AP type field, a 5-bit reserved field, a 1-bit UWB AP present field, a 3-bit type of UWB per-session info field, a 4-bit reserved field, and a 16-bit next NB AP field.

In some embodiments, the ID field of the second compressed PSDU is set as a different preset value (e.g., 0x00) to represent that the second compressed PSDU is configured to carry a wireless frame carrying the application information. In this case, the compressed PSDU may only include the ID field and the payload field, the payload field is configured to carry the wireless frame, and the wireless frame carries the application information. For the first communication apparatus, after receiving the PHY data unit from the second communication apparatus, the first communication apparatus may check the first octet of the payload field of the PHY data unit. If the value of the first octet of the payload field of the PHY data unit is 0x00, the first communication apparatus may determine that the payload field of the PHY data unit carries a compressed PSDU, and the payload field of the compressed PSDU carries a wireless frame carrying the application information; and if it is a value other than 0x00, the first communication apparatus may determine that the payload field of the PHY data unit carries a compressed PSDU not carrying the application information.

According to the above-mentioned embodiments, the compressed PSDU not carrying the application information is the first compressed PSDU, while the application information is carried by the second compressed PSDU. The first compressed PSDU and the second compressed PSDU may be distinguished based on the values of their ID fields. For convenience, the preset value which is used to indicate that the compressed PSDU carries the application information may be referred to as a second preset value. Therefore, when a value of an ID field of a compressed PSDU is the second preset value, the compressed PSDU is used for carrying the application information; or when a value of an ID field of a compressed PSDU is different from the second preset value, the compressed PSDU is not used for carrying the application information. In other words, the value of the ID field of the second compressed PSDU is the second preset value, while the value of the ID field of the first compressed PSDU is different from the second preset value.

In some embodiments, the type instruction information may be carried by a PHY header field of the PHY data unit. The PHY header includes 8 bits, and first 7 bits of the PHY header is a frame length field, and the last bit of the PHY header is a reserved bit. The last bit of the PHY header may be used as the type instruction information. For example, if the value of the last bit is 1, the payload of the PHY data unit may carry a compressed PSDU; and if the value of the last bit is 0, the payload of the PHY data unit may carry the wireless frame that is different from the compressed PSDU (e.g., a data frame). This is illustrated in FIG. 13.

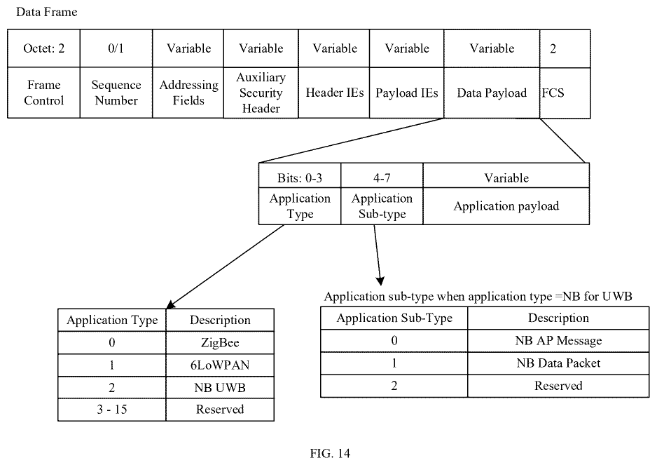

The NB AP message may be carried within the payload of the data frame. However, when an NB radio is also expected to receive other application information (e.g., a ZigBee message, a 6LoWPAN message, or an 802.15.4ab NB data applications such as payment gateways), a modulation method of a PHY data unit carrying the application information may be the same as a modulation method of the PHY data unit carrying the data frame that carries the NB AP message. As a result, the receiver is unable to distinguish PHY data units carrying different application information based on a modulation scheme, PHY data unit format, or the MAC frame carried by the PHY data unit. To address this problem, the data frame may include application type indication information. The application type indication information is configured to indicate a type of application information carried by the wireless frame. The type of the application information may be a ZigBee message, a 6LoWPAN message, or an NB UWB message. Therefore, the receiver is capable of distinguishing data units carrying different application information according to the application type indication information. In addition, the wireless frame may further include application sub-type indication information, and the application sub-type indication information indicates a sub-type of the application information carried by the wireless frame. For example, when the type of the application information is the NB UWB message, the sub-type of the NB UWB message may be an NB AP message or an NB data packet. Therefore, when the application type indication information indicates that the wireless frame carries the NB UWB message, the application sub-type indication information indicates that the NB UWB message is the NB AP message or the NB data packet. FIG. 14 illustrates the above-mentioned application type field and the application sub-type field.

Examples of the data frame carrying data of various application types and sub-types are illustrated in FIG. 15.

An NB radio could be to assist with the channel clear assessment (CCA) of the UWB channels. As mentioned above, due to the nature of UWB transmissions (wide bandwidth, and low transmission power), it is relatively harder to detect a UWB signal blindly (as compared to an NB signal). As such, in order to avoid accidental interference in the UWB channels, an NB channel could be tightly coupled with a UWB channel and any transmission in the UWB channel may be indicated using the NB channel by transmitting an NB signal on the coupled NB channel at the same time as the transmission in the UWB channel. Before starting any transmission in a UWB channel, a complaint device needs to first perform a CCA on the coupled NB channel. If the CCA result indicates a BUSY status (i.e., if the CCA detects an NB transmission in the NB channel), the device is not allowed to transmit in the UWB channel. Only if the CCA result indicates an IDLE status, the device may transmit in the UWB channel.

Since the purpose of the transmission on the coupled NB channel is only to signal the BUSY status of the coupled UWB channel, a PHY data unit transmitted on the coupled NB channel does not need to carry any payload. As such, a PHY data unit without any payload (i.e., the frame length field in the PHR is equal to 0) may be used, as shown in FIG. 16. For convenience, the PHY data unit carrying the control information or the application information may be referred to a first PHY data unit, and the PHY data unit without any payload (i.e., the frame length field in the PHY header (PHR) is equal to 0) may be referred to as a second PHY data unit, or an NB CCA PPDU. In addition to a frame length field in a PHR field of the second PHY data unit, the PHR field of the second PHY data unit further includes one reserved bit, and the reserved bit in the PHR field of the second PHY data unit may be used to indicate the start or end of a transmission in the coupled UWB channel as shown in FIG. 17. When the frame length field in the PHR field of the second PHY data unit is set to 0, the reserved bit may be referred to as a start transmission field and is set to b1 to signal the start of UWB transmission in the coupled UWB channel and is set to b0 to signal the end of UWB transmission in the coupled UWB channel.

FIG. 17 illustrates a relationship between the second PHY data unit and the UWB transmission.

Referring to FIG. 17, if the UWB transmission in the coupled UWB channel is shorter in duration than twice the transmission duration of the second PHY data unit, then a single second PHY data unit with the start transmission field set to b0 (end) is transmitted in the NB channel at the same time as the starting time of the UWB transmission. If the UWB transmission in the coupled UWB channel is equal to or longer in duration than twice the transmission duration of the second PHY data unit, then a second PHY data unit with the start transmission field set to b1 (start) is transmitted in the NB channel at the same time as the starting time of UWB transmission and a second PHY data unit with the start transmission field set to b0 (end) is transmitted in the NB channel such that the end time of the second PHY data unit coincides as the end time of the UWB transmission.

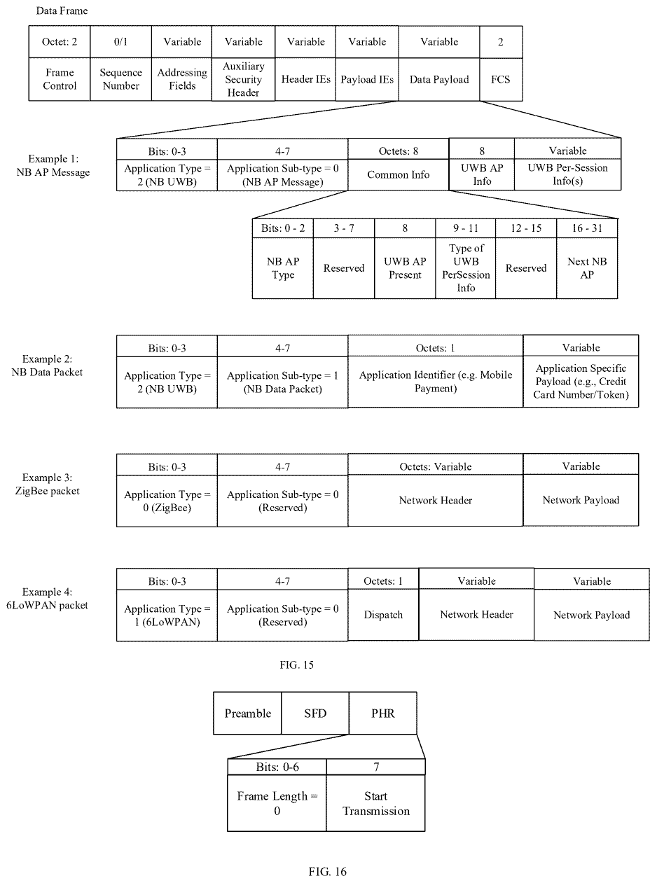

FIG. 18 is a schematic block diagram of a communication apparatus according to some embodiments of the present application. As shown in FIG. 18, the computing device 1800 includes: a communicating unit 1801 and a processing unit 1802.

The communicating unit 1801 is configured to receive a first PPDU, where the first PPDU includes type instruction information, where the type instruction information is configured to indicate whether the first PPDU carries a compressed PSDU.

The processing unit 1802 is configured to process information carried by the received PPDU.

It should be understood that the communication apparatus 1800 in this embodiment of this application may correspond to the first communication apparatus in the above-mentioned embodiments, and the foregoing and other management operations and/or functions of the units in the first communication apparatus are separately used to implement corresponding steps of the foregoing methods. For brevity, details are not described herein again.

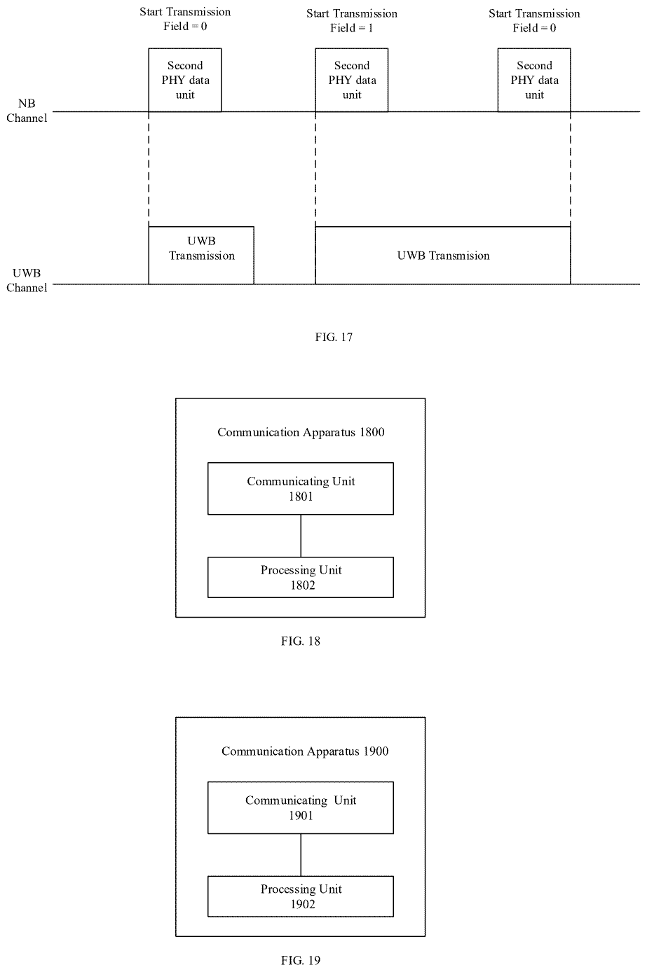

FIG. 19 is a schematic block diagram of A communication apparatus 1900 according to some embodiments of the present application. As shown in FIG. 19, the computing device 1900 includes: a communicating unit 1901 and a processing unit 1902.

The processing unit 1902 is configured to generate a first PPDU.

The communicating unit 1901 is configured to transmit the first PPDU, where the first PPDU includes type instruction information, where the type instruction information is configured to indicate whether the first PPDU carries a compressed PSDU.

It should be understood that the communication apparatus 1900 in this embodiment of this application may correspond to the second communication apparatus in the above-mentioned embodiments, and the foregoing and other management operations and/or functions of the units in the second communication apparatus are separately used to implement corresponding steps of the foregoing methods. For brevity, details are not described herein again.

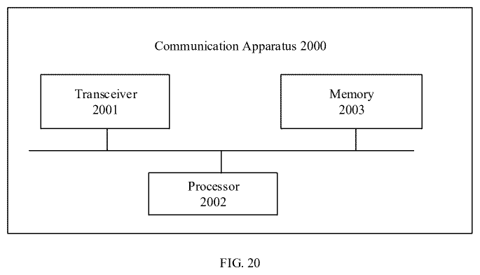

As shown in FIG. 20, a communication apparatus 2000 may include a transceiver 2001, a processor 2002, and a memory 2003. The memory 2003 may be configured to store code, instructions, and the like executed by the processor 2002.

It should be understood that the processor 2002 may be an integrated circuit chip and has a signal processing capability. In an implementation process, steps of the foregoing method embodiments may be completed by using a hardware integrated logic circuit in the processor, or by using instructions in a form of software. The processor may be a general purpose processor, a central processing unit (CPU), a graphics processing unit (GPU), a neural processing unit (NPU), a system on chip (SoC) or another programmable logic device, a discrete gate or transistor logic device, or a discrete hardware component. The processor may implement or perform the methods, the steps, and the logical block diagrams that are disclosed in the embodiments of the present application. The general purpose processor may be a microprocessor, or the processor may be any conventional processor or the like. The steps of the methods disclosed with reference to the embodiments of the present application may be directly performed and completed by a hardware decoding processor, or may be performed and completed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps of the foregoing methods in combination with hardware in the processor.

It may be understood that the memory 2003 in the embodiments of the present application may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM) and is used as an external cache. By way of example rather than limitation, many forms of RAMs may be used, and are, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), and a direct rambus random access memory (DR RAM).

In some embodiments, the communication apparatus 2000 may be the first communication apparatus mentioned in the embodiments of the present application, and the memory 2003 stores the instructions When the instructions are performed by the processor 2002, the communication apparatus 2000 is enabled to perform the foregoing methods performed by the first communication apparatus.

In some other embodiments, the communication apparatus 2000 may be the second communication apparatus mentioned in the embodiments of the present application, and the memory 2003 stores the instructions When the instructions are performed by the processor 2002, the communication apparatus 2000 is enabled to perform the foregoing methods performed by the second communication apparatus.

It should be noted that the memory described in this specification includes but is not limited to these memories and a memory of any other appropriate type.

An embodiment of this application further provides a system chip, where the system chip includes an input/output interface, at least one processor, at least one memory, and a bus. The at least one memory is configured to store instructions, and the at least one processor is configured to invoke the instructions of the at least one memory and run the instructions, so that a communication apparatus on which the chip is disposed performs methods in the foregoing embodiments.

In some embodiments, the communication apparatus on which the chip is disposed is the first communication apparatus, and the at least one memory is configured to store instructions to perform operations in the methods performed by the first communication apparatus.

In some other embodiments, the communication apparatus on which the chip is disposed is the second communication apparatus, and the at least one memory is configured to store instructions to perform operations in the methods performed by the second communication apparatus.

An embodiment of this application further provides a computer storage medium, where the computer storage medium may store instructions. When the instructions run on a computer, the computer is enabled to perform the foregoing methods.

In some embodiments, the instructions stored in the computer storage medium are used to perform operations in the methods performed by the first communication apparatus.

In some other embodiments, the instructions stored in the computer storage medium are used to perform operations in the methods performed by the second communication apparatus.

Optionally, the storage medium may be the memory 2003.

A person of ordinary skill in the art may be aware that, in combination with the examples described in the embodiments disclosed in this specification, units and algorithm steps can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiment. Details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in a form of a software functional unit and sold or used as an independent product, the functions may be stored in a computer readable storage medium. Based on such an understanding, the technical solutions in this application essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this application. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
receiving a physical layer (PHY) protocol data unit (PPDU), wherein the PPDU comprises type instruction information indicating whether the PPDU carries a compressed physical layer (PHY) service data unit (PSDU); and
processing the information carried by the received PPDU.

2. The method according to claim 1, wherein the type instruction information is carried by a payload field of the PPDU.

3. The method according to claim 1, wherein the type instruction information occupies N bits within the payload of the PPDU, N is a positive integer,
when a value of the N bits of the payload field of the PPDU is a first preset value, the PPDU carries the compressed PSDU.

4. The method according to claim 1, wherein a payload field of the PPDU comprises a first 3-bit field indicating the type instruction information and a second 5-bit field indicating a type of information carried by the compressed PSDU.

5. The method according to claim 3, wherein the first preset value is 100.

6. The method according to claim 1, wherein the PPDU comprises a message control field, and the message control field comprises a common information (info) field, a ultra-wideband access point (UWB AP) info field, and UWB Per-Session Info(s) field.

7. The method according to claim 6, wherein the common info field comprises a narrowband (NB) AP Type field, a UWB AP Present field, a Type of UWB Per-Session Info field and a Next NB AP field.

8. A communication method, comprising:
generating a physical layer (PHY) protocol data unit (PPDU);
transmitting the PPDU, wherein the PPDU comprises type instruction information indicating whether the PPDU carries a compressed PHY service data unit (PSDU).

9. The method according to claim 8, wherein the type instruction information is carried by a payload field of the PPDU.

10. The method according to claim 8, wherein the type instruction information occupies N bits within the payload of the PPDU, N is a positive integer,
when a value of the N bits of the payload field of the PPDU is a first preset value, the PPDU carries the compressed PSDU.

11. The method according to claim 9, wherein a payload field of the PPDU comprises a first 3-bit field indicating the type instruction information, and a second 5-bit field indicating a type of information carried by the compressed PSDU.

12. The method according to claim 10, wherein the first preset value is 100.

13. The method according to claim 8, wherein the PPDU comprises a message control field, and the message control field comprises a common information (info) field, a ultra-wideband access point (UWB AP) info field, and UWB Per-Session Info(s) field.

14. The method according to claim 13, wherein the common info field comprises a narrowband (NB) AP Type field, a UWB AP Present field, a Type of UWB Per-Session Info field and a Next NB AP field.

15. A communication apparatus, comprising:
a processor, configured to execute the instructions stored in a memory, to cause the communication apparatus to perform the operations:
receiving a physical layer (PHY) protocol data unit (PPDU), wherein the PPDU comprises type instruction information indicating whether the PPDU carries a compressed PHY service data unit (PSDU); and
processing the information carried by the received PPDU.

16. The communication apparatus according to claim 15, wherein the type instruction information occupies N bits within the payload of the PPDU, N is a positive integer,
when a value of the N bits of the payload field of the PPDU is a first preset value, the PPDU carries the compressed PSDU, wherein the first preset value is 100.

17. The communication apparatus according to claim 15, wherein the PPDU comprises a message control field, and the message control field comprises a common information (info) field, a ultra-wideband access point (UWB AP) info field, and UWB Per-Session Info(s) field.

18. The communication apparatus according to claim 17, wherein the common info field comprises a narrowband (NB) AP Type field, a UWB AP Present field, a Type of UWB Per-Session Info field and a Next NB AP field.

19. A communication apparatus, comprising:
a processor, configured to execute the instructions stored in a memory, to cause the communication apparatus to perform the operations:
generating a physical layer (PHY) data unit (PPDU);
transmitting the PPDU, wherein the PPDU comprises type instruction information indicating whether the PPDU carries a compressed PHY service data unit (PSDU).

20. The communication apparatus according to claim 19, wherein the type instruction information occupies N bits within the payload of the PPDU, N is a positive integer,
when a value of the N bits of the payload field of the PPDU is a first preset value, the PPDU carries the compressed PSDU, wherein the first preset value is 100.
